(19) United States
(12) Patent Application Publication
(10) Pub. No.: US 2026/0360597 A1
(43) Pub. Date: Nov. 12, 2026

(54) GRAIN-ORIENTED ELECTRICAL STEEL SHEET AND INSULATING COATING FORMING METHOD

(71) Applicant: NIPPON STEEL CORPORATION, Tokyo (JP)

(72) Inventors: Kazutoshi TAKEDA, Tokyo (JP); Shinsuke TAKATANI, Tokyo (JP); Yuuki KOGAKURA, Tokyo (JP); Hiroyasu FUJII, Tokyo (JP)

(73) Assignee: NIPPON STEEL CORPORATION, Tokyo (JP)

(21) Appl. No.: 19/470,223

(22) PCT Filed: Apr. 5, 2024
(86) PCT No.: PCT/JP2024/014111

§ 371 Date: Sep. 29, 2025

(30) Foreign Application Priority Data
Apr. 5, 2023 (JP) 2023-061322

(51) Int. Cl. H01F 1/147; C21D 1/74; C21D 6/00; C21D 8/1216; C21D 8/1244; C21D 8/1277; C21D 9/46; C22C 38/00; C22C 38/02; C22C 38/04; C22C 38/06

(52) U.S. Cl. CPC H01F 1/14783; C21D 1/74; C21D 6/005; C21D 6/008; C21D 8/1222; C21D 8/1233; C21D 8/1255; C21D 8/1261; C21D 8/1283; C21D 9/46; C22C 38/001; C22C 38/02; C22C 38/04; C22C 38/06; C21D 2201/05; C22C 2202/02

(57) ABSTRACT

This grain-oriented electrical steel sheet includes a base steel sheet, a glass coating formed on a surface of the base steel sheet, and an insulating coating formed on a surface of the glass coating, in which the base steel sheet has a sheet thickness of 0.15 to 0.35 mm, the insulating coating contains a metal phosphate, amorphous silica, and an alkaline earth metal element other than magnesium, the amorphous silica being contained in an amount of 50 to 150 parts by mass, and the alkaline earth metal element being contained in an amount of 1.0 to 20 parts by mass in total with respect to 100 parts by mass of the metal phosphate, and the insulating coating has a water content of 0 to 0.04 mass %.

### TECHNICAL FIELD

The present invention relates to a grain-oriented electrical steel sheet and a method for forming an insulating coating included in the grain-oriented electrical steel sheet. Priority is claimed on Japanese Patent Application No. 2023-061322, filed Apr. 5, 2023, the content of which is incorporated herein by reference.

### BACKGROUND ART

A grain-oriented electrical steel sheet is a steel sheet mainly used as an iron core of a transformer or the like. Usually, on such a grain-oriented electrical steel sheet, a forsterite layer (also referred to as a forsterite film, a glass coating, or a primary coating) formed during high-temperature finishing annealing, and an insulating coating formed by applying a treatment liquid containing a phosphate or the like as a main component, and then performing baking during heat flattening of the steel sheet are formed.

The insulating coating is required to impart an electrical insulation property to the grain-oriented electrical steel sheet, and to reduce eddy-current loss and improve iron loss. The insulating coating is required to have various properties such as corrosion resistance, heat resistance, slidability, and adhesion in addition to insulation properties. This is to facilitate various manufacturing processes when the grain-oriented electrical steel sheet is processed into an iron core of a transformer or the like. For example, when the heat resistance, slidability, and adhesion of the insulating coating are poor, the insulating coating may peel off during the stress relief annealing in iron core manufacturing, so that the original insulation property may not be exhibited or the steel sheet may not be smoothly laminated, resulting in deterioration in workability.

Further, as an important characteristic of the insulating coating of the grain-oriented electrical steel sheet, there is an action to apply tension to the steel sheet. When tension is applied to the steel sheet, the iron loss of the grain-oriented electrical steel sheet can be improved by facilitating the movement of the domain wall. It is also possible to reduce the magnetic strain, which is one of the main causes of noise generated by a transformer manufactured by using a grain-oriented electrical steel sheet as an iron core, by applying tension.

In order to improve various characteristics of the grain-oriented electrical steel sheet as described above, specifically, techniques as disclosed in the following Patent Documents 1 to 7 have been researched and developed.

For example, Patent Document 1 discloses a technique in which an insulating coating treatment liquid containing a phosphate, a chromate, and colloidal silica having a specific composition as main components is applied onto a forsterite film formed on a sheet surface after finishing annealing and then baked. According to the technique disclosed in Patent Document 1, it is possible to form an insulating coating having high tension on the sheet surface and to reduce iron loss and magnetic strain of the grain-oriented electrical steel sheet.

Patent Document 2 discloses a method in which a treatment liquid containing ultrafine colloidal silica having a grain size of 8 μm or less, a first phosphate, and a chromate at a specific ratio is applied to a steel sheet and then baked. According to the technique disclosed in Patent Document 2, it is possible to maintain high tension of the insulating coating and further improve lubricity of the coating.

Furthermore, Patent Document 3 discloses a technique in which a specific amount of an insulating coating containing a phosphate, a chromate, and colloidal silica having a glass transition point of 950 °C to 1200 °C as main components is attached to form a high-tension insulating coating on a surface of a grain-oriented electrical steel sheet.

According to the techniques disclosed in Patent Documents 1 to 3, it has been possible to form an insulating coating having various significantly superior coating characteristics and improved coating tension. However, in all the techniques disclosed in Patent Documents 1 to 3, the chromate which is a chromium compound is contained in the insulating coating. In recent years, with the growing focus on environmental problems, it is socially required to prohibit or restrict the use of compounds such as lead, chromium, and cadmium.

Thus, a technique capable of forming a good insulating coating without a chromium compound being contained has been studied. For example, Patent Document 4 discloses a method for treating an insulating coating of a grain-oriented electrical steel sheet in which a treatment liquid containing 20 parts by mass of colloidal silica in terms of SiO₂ content, 10 to 120 parts by mass of an aluminum phosphate, 2 to 10 parts by mass of boric acid, and a sulfate of one or two or more metal elements selected from Mg, Al, Fe, Co, Ni, and Zn in a total amount of 4 to 40 parts by mass is baked at 300 °C or higher.

In addition, Patent Document 5 discloses a technique related to a coating agent for forming a coating which contains a mixture of boric acid and alumina sol and an organic solvent having compatibility with water and has a tension applying effect on a grain-oriented electrical steel sheet.

Patent Document 6 discloses a technique of adding an organic acid salt of one or two or more metal elements selected from Ca, Mn, Fe, Zn, Co, Ni, Cu, B, and Al in a surface treatment agent for a grain-oriented electrical steel sheet containing a phosphate and colloidal silica. In addition, in Patent Document 6, formate, acetate, oxalate, tartrate, lactate, citrate, succinate, and salicylate are exemplified as the organic acid salt.

Furthermore, Patent Document 7 discloses a technique in which a metal component in a phosphate is a combination of specific ratios of a divalent metal element, a trivalent metal element, and a tetravalent or higher metal element in an insulating coating treatment agent for a grain-oriented electrical steel sheet containing a phosphate and colloidal silica.

However, in the insulating coating disclosed in Patent Document 4, the corrosion resistance of the steel sheet may be reduced due to sulfate ions in the sulfate. In addition, in the technique disclosed in Patent Document 5, since the corrosion resistance and the baking temperature of the insulating coating are too high, the steel sheet is likely to be scratched. In the technique disclosed in Patent Document 6, the solution of the surface treatment agent is discolored by the organic acid in the organic acid salt, and the liquid stability is low. Furthermore, in the technique disclosed in Patent Document 7, the preparation of the coating liquid is complicated, and the concentration of the coating solution cannot be increased, so that uniform coating is difficult.

In addition, the insulating coating not containing chromate disclosed in Patent Document 4 to 7 cannot apply sufficient tension to the steel sheet, and therefore it cannot be said that the iron loss of the grain-oriented electrical steel sheet can be sufficiently improved. Therefore, the technique related to the insulating coatings of these grain-oriented electrical steel sheets required further improvement.

### CITATION LIST

### Patent Documents

Patent Document 1: Japanese Examined Patent Application, Second Publication No. S53-28375
Patent Document 2: Japanese Unexamined Patent Application, First Publication No. S61-41778
Patent Document 3: Japanese Unexamined Patent Application, First Publication No. H11-071683
Patent Document 4: Japanese Examined Patent Application, Second Publication No. S57-9631
Patent Document 5: Japanese Unexamined Patent Application, First Publication No. H07-278828
Patent Document 6: Japanese Unexamined Patent Application, First Publication No. 2000-178760
Patent Document 7: Japanese Unexamined Patent Application, First Publication No. 2010-13692

### SUMMARY OF INVENTION

### Technical Problem

As described above, there is room for improvement in the insulating coating containing no chromate.

In addition, there is a problem that the amount of phosphoric acid eluted from the insulating coating increases in the case of attempting to improve the above characteristics in the insulating coating containing no chromate.

In particular, conventionally, it has been difficult to achieve both enhancement of the coating tension and reduction of the dissolution amount of phosphoric acid. It has been studied to improve the coating tension and the curbing of dissolution of phosphoric acid by controlling a crystallization state of a phosphate of a binder or combining metal phosphates containing metal elements having different valences, but since the coating tension and the curbing of dissolution of phosphoric acid vary depending on baking conditions and the like, there is a lot of room for improvement in order to obtain industrially stable effects. In addition, so-called two-time coating in which a solution containing a metal phosphate having a high coating tension is applied and dried, and then a solution capable of reducing eluted phosphorus is applied and dried has been studied, but there is a problem in terms of cost.

Therefore, an object of the present invention is to provide, on the premise of a grain-oriented electrical steel sheet having an insulating coating containing no chromate, which has corrosion resistance, coating adhesion, and coating tension equal to or higher than conventional ones, a grain-oriented electrical steel sheet having a small amount of phosphoric acid eluted from the insulating coating (exceptional in dissolution resistance), and a method for forming the insulating coating (insulating coating forming method).

### Solution to Problem

The present inventors have studied curbing of dissolution of phosphoric acid in an insulating coating containing no chromate. As a result, it has been found that dissolution of phosphoric acid is curbed in an insulating coating obtained by applying an insulating coating solution containing a predetermined alkaline earth metal element.

The present invention has been made in view of the above findings. The gist of the present invention is as follows.
[1] A grain-oriented electrical steel sheet according to an aspect of the present invention includes a base steel sheet; a glass coating formed on a surface of the base steel sheet; and an insulating coating formed on a surface of the glass coating, in which the base steel sheet has a sheet thickness of 0.15 to 0.35 mm, the insulating coating contains a metal phosphate, amorphous silica, and an alkaline earth metal element other than magnesium, the amorphous silica being contained in an amount of 50 to 150 parts by mass, and the alkaline earth metal element being contained in an amount of 1.0 to 20 parts by mass in total with respect to 100 parts by mass of the metal phosphate, and the insulating coating has a water content of 0 to 0.04 mass %.
[2] In the grain-oriented electrical steel sheet according to [1], the alkaline earth metal element may be one kind or two or more kinds selected from Ca, Sr, and Ba.
[3] An insulating coating forming method according to another aspect of the present invention includes a solution preparation step of preparing an insulating coating solution containing 50 to 150 parts by mass of colloidal silica in terms of silica content and 1.25 to 83.3 parts by mass of a hydroxide or a hydrogen carbonate of an alkaline earth metal element other than magnesium with respect to 100 parts by mass of a metal phosphate, the insulating coating solution having a solid content concentration of 8 to 50 mass %; and a coating and drying step of applying the insulating coating solution to a steel sheet, heating the steel sheet to a temperature range of 800 to 900 °C so that a heating rate between 100 and 600 °C is 40 to 200 °C/sec, and holding the insulating coating solution in the temperature range for 5 to 90 seconds.
[4] In the insulating coating forming method according to [3], in the solution preparation step, 1 to 5 parts by mass of phosphonic acid with respect to 100 parts by mass of the metal phosphate may be added to the insulating coating solution.

### Advantageous Effects of Invention

According to the above aspect of the present invention, it is possible to provide a grain-oriented electrical steel sheet in which the amount of phosphoric acid eluted from an insulating coating is small, and a method for forming the insulating coating.

### DESCRIPTION OF EMBODIMENTS

A grain-oriented electrical steel sheet (grain-oriented electrical steel sheet according to the present embodiment) according to an embodiment of the present invention includes a base steel sheet, a glass coating formed on a surface of the base steel sheet, and an insulating coating formed on a surface of the glass coating.

In the grain-oriented electrical steel sheet according to the present embodiment, the base steel sheet has a sheet thickness of 0.15 to 0.35 mm, the insulating coating contains a metal phosphate, amorphous silica, and an alkaline earth metal element other than magnesium, the amorphous silica is contained in an amount of 50 to 150 parts by mass and the alkaline earth metal element is contained in an amount of 1.0 to 20 parts by mass in total, with respect to 100 parts by mass of the metal phosphate, and the insulating coating has a water content of 0 to 0.04 mass %.

Each will be described below.

### [Base Steel Sheet]

The grain-oriented electrical steel sheet according to the present embodiment has a major feature in the insulating coating, and the base steel sheet included in the grain-oriented electrical steel sheet is not limited in chemical composition, which may be within known ranges. For example, in order to obtain characteristics generally required for a grain-oriented electrical steel sheet, the grain-oriented electrical steel sheet preferably contains the following components. In the present embodiment, % related to the content of an element is mass % unless otherwise specified.

### C: 0.010% or Less

C (carbon) is an element effective in controlling the microstructure of the steel sheet in steps up to completion of the decarburization annealing step in the manufacturing process. However, when the C content exceeds 0.010%, the magnetic characteristics of the grain-oriented electrical steel sheet, which is a product sheet, deteriorate. Therefore, in the base steel sheet of the grain-oriented electrical steel sheet according to the present embodiment, the C content is preferably 0.010% or less. The C content is more preferably 0.005% or less. The C content is preferably as low as possible, but even when the C content is reduced to less than 0.0001%, a microstructure control effect is saturated, and manufacturing cost is merely increased. Therefore, the C content may be 0.0001% or more.

### Si: 2.00 to 6.00%

Si (silicon) is an element that increases the electric resistance of a grain-oriented electrical steel sheet and improves iron loss characteristics. When the Si content is less than 2.00%, a sufficient eddy-current loss reducing effect cannot be obtained. Therefore, the Si content is preferably 2.00% or more. The Si content is more preferably 2.50% or more, and still more preferably 3.00% or more.

On the other hand, when the Si content exceeds 6.00%, the grain-oriented electrical steel sheet is embrittled, and passability significantly deteriorates. In addition, workability of the grain-oriented electrical steel sheet deteriorates, and the steel sheet may be fractured during rolling. Therefore, the Si content is preferably set to 6.00% or less. The Si content is more preferably 5.00% or less, and still more preferably 4.00% or less.

### Mn: 0.01 to 0.50%

Mn (manganese) is an element that is bonded to S in a manufacturing process to form MnS. This precipitate functions as an inhibitor (inhibitor for normal grain growth) and causes secondary recrystallization in steel. Mn is also an element that enhances hot workability of steel. When the Mn content is less than 0.01%, the above effect cannot be sufficiently obtained. Therefore, the Mn content is preferably 0.01% or more. The Mn content is more preferably 0.02% or more.

On the other hand, when the Mn content exceeds 0.50%, secondary recrystallization does not occur, and the magnetic characteristics of steel deteriorate. Therefore, in the base steel sheet of the grain-oriented electrical steel sheet according to the embodiment, the Mn content is preferably 0.50% or less. The Mn content is more preferably 0.20% or less, and still more preferably 0.10% or less.

### N: 0.010% or Less

N (nitrogen) is an element that is bonded to Al in the manufacturing process to form AlN that functions as an inhibitor. However, when the N content is more than 0.010%, magnetic characteristics deteriorate due to an inhibitor excessively remaining in the base steel sheet. Therefore, in the base steel sheet of the grain-oriented electrical steel sheet according to the embodiment, the N content is preferably 0.010% or less. The N content is more preferably 0.008% or less.

On the other hand, the lower limit value of the N content is not particularly limited, but even when the N content is reduced to less than 0.001%, manufacturing cost is merely increased. Therefore, the N content may be 0.001% or more.

Sol. Al: 0.020% or Less

Al (aluminum) is an element that is bonded to N in the manufacturing process of the grain-oriented electrical steel sheet to form AlN that functions as an inhibitor. However, when the sol. Al (acid-soluble aluminum) content of the base steel sheet exceeds 0.020%, magnetic characteristics deteriorate due to an inhibitor excessively remaining in the base steel sheet. Therefore, in the base steel sheet of the grain-oriented electrical steel sheet according to the embodiment, the sol. Al content is preferably 0.020% or less. The sol. Al content is more preferably 0.010% or less, and still more preferably less than 0.001%. The lower limit value of the sol. Al content is not particularly limited, but even when the content is reduced to less than 0.0001%, manufacturing cost is merely increased. Therefore, the sol. Al content may be 0.0001% or more.

### S: 0.010% or Less

S (sulfur) is an element that is bonded to Mn in the manufacturing process to form MnS that functions as an inhibitor. However, when the S content exceeds 0.010%, an excessively remaining inhibitor causes magnetic characteristics to deteriorate. Therefore, in the base steel sheet of the grain-oriented electrical steel sheet according to the present embodiment, the S content is preferably 0.010% or less. The S content is more preferably as low as possible in the grain-oriented electrical steel sheet. For example, the S content is less than 0.001%. However, even when the S content is reduced to less than 0.0001% in the grain-oriented electrical steel sheet, manufacturing cost is merely increased. Therefore, the S content may be 0.0001% or more in the grain-oriented electrical steel sheet.

### P: 0.030% or Less

P (phosphorus) is an element that lowers the workability in rolling. When the P content is 0.030% or less, it is possible to curb excessive reduction in rolling workability and to curb fracture during manufacturing. From such a viewpoint, the P content is preferably 0.030% or less. The P content is more preferably 0.020% or less, and further preferably 0.010% or less.

The lower limit of the P content may include 0%, but since the detection limit of chemical analysis is 0.0001%, the actual lower limit of the P content in a practical steel sheet is 0.0001%. In addition, P is also an element having an effect of improving the texture and improving the magnetic characteristics. In order to obtain this effect, the P content may be 0.001% or more or 0.005% or more.

### Remainder: Fe and Impurities

The chemical composition of the base steel sheet of the grain-oriented electrical steel sheet according to the present embodiment may contain the above-described elements, with the remainder of Fe and impurities. However, for the purpose of improving magnetic characteristics and the like, Cu, Cr, Sn, Se, Sb, and Mo may be further contained in the following ranges. These elements are also allowed to be contained as impurities. The lower limit of the content is 0% because the elements may not be contained.

In addition, even if any one of, or two or more of, for example, W, Nb, Ti, Ni, Bi, Co, and V are contained as elements other than these in a total amount of 1.0% or less (regardless of whether intentionally added as impurities), the effect of the grain-oriented electrical steel sheet according to the present embodiment is not inhibited.

Here, the impurity is an element that is a contaminant derived from ore or scrap as a raw material, a manufacturing environment, or the like when the base steel sheet is industrially manufactured, and means an element that is allowed to be included in a content that does not adversely affect the effect of the grain-oriented electrical steel sheet according to the embodiment.

### Cr: 0 to 0.50%

Cr (chromium) is an element that contributes to an increase in Goss orientation occupancy rate in the secondary recrystallization structure to improve magnetic characteristics. In order to obtain the above effect, the Cr content is preferably 0.01% or more, more preferably 0.02% or more, and still more preferably 0.03% or more.

On the other hand, when the Cr content exceeds 0.50%, Cr oxide is formed, and the magnetic characteristics deteriorate. Therefore, the Cr content is preferably 0.50% or less. The Cr content is more preferably 0.30% or less, and still more preferably 0.10% or less.

### Sn: 0 to 0.50%

Sn (tin) is an element that contributes to improvement in magnetic characteristics through primary recrystallization structure control. In order to obtain an effect of improving magnetic characteristics, the Sn content is preferably 0.01% or more. The Sn content is more preferably 0.02% or more, and still more preferably 0.03% or more.

On the other hand, when the Sn content exceeds 0.50%, secondary recrystallization is unstable, and magnetic characteristics deteriorate. Therefore, the Sn content is preferably 0.50% or less. The Sn content is more preferably 0.30% or less, and still more preferably 0.10% or less.

### Cu: 0 to 0.50%

Cu (copper) is an element that contributes to an increase in Goss orientation occupancy rate in a secondary recrystallization structure. Cu is an optional element in the base steel sheet according to the present embodiment. Therefore, the lower limit of the content is 0%. In order to obtain the above effect, the Cu content is preferably 0.01% or more. The Cu content is more preferably 0.02% or more, and still more preferably 0.03% or more.

On the other hand, when the Cu content exceeds 0.50%, the steel sheet is embrittled during hot rolling. Therefore, in the base steel sheet of the grain-oriented electrical steel sheet according to the embodiment, the Cu content is preferably 0.50% or less. The Cu content is more preferably 0.30% or less, and still more preferably 0.10% or less.

### Se: 0 to 0.020%

Se (selenium) is an element having an effect of improving magnetic characteristics. Thus, Se may be contained. When Se is contained, the content is preferably 0.001% or more such that Se favorably exhibits the effect of improving magnetic characteristics. The Se content is preferably 0.003% or more and more preferably 0.006% or more.

On the other hand, when the Se content exceeds 0.020%, adhesion of the glass coating deteriorates. Therefore, the Se content is preferably s 0.020% or less. The Se content is more preferably 0.015% or less, and still more preferably 0.010% or less.

### Sb: 0 to 0.500%

Sb (antimony) is an element having an effect of improving magnetic characteristics. Thus, Sb may be contained. When Sb is contained, the content is preferably 0.005% or more such that Sb favorably exhibits the effect of improving magnetic characteristics. The Sb content is more preferably 0.010% or more, and still more preferably 0.020% or more.

On the other hand, when the Sb content exceeds 0.500%, the adhesion of the glass coating significantly deteriorates. Therefore, the Sb content is preferably 0.500% or less. The Sb content is more preferably 0.300% or less, and still more preferably 0.100% or less.

### Mo: 0 to 0.10%

Mo (molybdenum) is an element having an effect of improving magnetic characteristics. Thus, Mo may be contained. When Mo is contained, the Mo content is preferably 0.01% or more in order to favorably exhibit the effect of improving magnetic characteristics. The Mo content is more preferably 0.02% or more, and still more preferably 0.03% or more.

On the other hand, when the Mo content is more than 0.10%, the cold rolling characteristics may deteriorate, leading to fracture. Therefore, the Mo content is preferably 0.10% or less. The Mo content is more preferably 0.08% or less, and still more preferably 0.05% or less.

As described above, the chemical composition of the base steel sheet of the grain-oriented electrical steel sheet in the present embodiment includes the above-described essential elements, and the remainder includes Fe and impurities, or includes the above-described essential elements, and further includes one or more optional elements, and the remainder includes Fe and impurities.

The chemical composition of the base steel sheet of the grain-oriented electrical steel sheet according to the present embodiment can be measured after the glass coating and the insulating coating formed on the surface are removed.

Specifically, the grain-oriented electrical steel sheet is immersed in a sodium hydroxide aqueous solution containing NaOH: 10 to 20 mass % at 80 to 90 °C for 7 to 10 minutes to remove the insulating coating.

The grain-oriented electrical steel sheet from which the insulating coating has been removed is washed with water, and then dried with a warm air blower for slightly less than 1 minute (for example, 5 to 60 seconds). The grain-oriented electrical steel sheet after drying (grain-oriented electrical steel sheet not provided with an insulating coating) is immersed in a hydrochloric acid aqueous solution containing 5 to 10 mass % of HCl and at 70 to 90 °C for 1 to 10 minutes to remove the glass coating.

The base steel sheet after immersion is washed with water, and then dried with a warm air blower for slightly less than 1 minute (for example, 5 to 60 seconds).

Through the above steps, the base steel sheet can be taken out from the grain-oriented electrical steel sheet.

The chemical composition of such a base steel sheet is obtained by using a well-known component analysis method. Specifically, swarf is generated from the base steel sheet by using a drill, the swarf is recovered, and the recovered swarf is dissolved in an acid to obtain a solution. The solution is subjected to ICP-AES to perform elemental analysis of the chemical composition.

Here, Si in the chemical composition of the base steel sheet is obtained by using a method (silicon quantitative method) specified in JIS G1212 (1997). Specifically, when the above-described swarf is dissolved in an acid, silicon oxide is separated as a precipitate, and thus the precipitate (silicon oxide) is filtered with filter paper, and the mass is measured to obtain the Si content.

The C content and the S content are obtained by using a well-known high frequency combustion method (combustion-infrared absorption method). Specifically, the above-described solution is combusted by high-frequency heating in an oxygen stream, and generated carbon dioxide and sulfur dioxide are detected to obtain the C content and the S content.

The N content is obtained by using a well-known inert gas fusion-thermal conductivity method.

### <Sheet Thickness>

The sheet thickness of the base steel sheet is 0.15 to 0.35 mm in consideration of the application of a transformer to an iron core. As the sheet thickness becomes smaller, an effect of reducing eddy-current loss can be obtained and a preferable iron loss can be obtained. Therefore, the upper limit of the sheet thickness of the base steel sheet is preferably 0.35 mm. On the other hand, special equipment is required to manufacture a base steel sheet having a sheet thickness of less than 0.15 mm, which is not preferable in terms of production such as an increase in manufacturing cost. Therefore, the lower limit of the sheet thickness is industrially preferably 0.15 mm.

### [Glass Coating]

In the grain-oriented electrical steel sheet according to the present embodiment, a glass coating (which may be also referred to as forsterite film) is formed on the surface of the base steel sheet. The glass coating may be any known coating. It is generally an inorganic coating containing magnesium silicate (forsterite) as a main component.

The glass coating is formed in finishing annealing when an annealing separator including magnesia (MgO) applied on the surface of the base steel sheet reacts with a component in the surface of the base steel sheet. The glass coating has a composition derived from the annealing separator and the component of the base steel sheet, and has a microstructure including a Mg₂SiO₄ phase as a main phase (50 area % or more) and an MgAl₂O₄ phase. In addition to these phases, a precipitate may be included in an amount of about 1% or less.

The glass coating contributes to improvement of adhesion of the insulating coating.

### [Insulating Coating]

In the grain-oriented electrical steel sheet according to the present embodiment, the insulating coating is formed on the surface of the glass coating.

The insulating coating contains a metal phosphate, amorphous silica, and an alkaline earth metal element other than magnesium, and the amount of the amorphous silica is 50 to 150 parts by mass and the amount of the alkaline earth metal element is 1.0 to 20 parts by mass in total, with respect to 100 parts by mass of the metal phosphate.

The amorphous silica is derived from colloidal silica in the insulating coating solution. When the proportion of the amorphous silica derived from the colloidal silica in the insulating coating solution is excessive, coating cracks or the like occurs, and the water content of the insulating coating increases. In addition, when the proportion of the amorphous silica is excessively low, the proportion of the phosphate becomes higher than necessary, and the water content of the insulating coating increases.

As a result of studies by the present inventors, it is assumed that the reason why the dissolution amount of phosphoric acid increases when chromic acid is not contained is that when an insulating coating solution containing no chromic acid is applied to a steel sheet having a glass coating, a forsterite layer on a surface of the steel surface reacts with the solution to generate magnesium phosphate having high moisture absorption property and solubility.

Therefore, in the grain-oriented electrical steel sheet according to the present embodiment, in order to curb the reaction between the insulating coating solution and forsterite and to minimize the amount of magnesium phosphate produced, an element forming a compound, which is more likely to react with phosphoric acid than magnesium or has lower solubility even though reactivity is equivalent, is added to the insulating coating solution. More specifically, hydroxides and hydrogen carbonates of specific alkaline earth metal elements excluding magnesium are added. Therefore, the formed insulating coating contains an alkaline earth metal element.

Specifically, the content of the alkaline earth metal element (as an alkaline earth metal) other than magnesium is 1.0 to 20 parts by mass in total with respect to 100 parts by mass of the metal phosphate. However, when the alkaline earth metal is an organic acid, a gas is generated from the organic acid at the time of baking to cause voids and cracks, and corrosion resistance and uniformity deteriorate. Therefore, the alkaline earth metal is present not as an organic acid but as an inorganic compound in the insulating coating. The inorganic compound is, for example, a metal phosphate.

When the proportion of the alkaline earth metal element is excessively small, the above effect cannot be obtained. On the other hand, when the proportion is excessively large, the solution becomes unstable or corrosion resistance decreases.

The alkaline earth metal element basically has the above effect but is an alkaline earth metal element other than magnesium because the effect is not obtained by magnesium. From the viewpoint of supply stability, the alkaline earth metal element is preferably one or more kinds selected from Ca, Sr, and Ba. In particular, Sr is preferable.

The presence state of the metal phosphate, the amorphous silica, and the alkaline earth metal compound in the insulating coating, and the proportion of the alkaline earth metal can be obtained by using the following method.

The proportions of a phosphate, silica, and an alkaline earth metal can be calculated by detecting and analyzing each element in the insulating coating by using the energy dispersive X-ray analyzer. Further, it is possible to calculate the proportion of amorphous silica in silica by using X-ray crystallography. In addition, since the alkaline earth metal is present in the same place as the metal phosphate, it can be determined that the alkaline earth metal is in a state of being combined with the metal phosphate.

When each element is detected by the energy dispersive X-ray analyzer, it is preferable to analyze about 3 points at a magnification of 1000 times to calculate an average value. Specifically, when crystallography is performed, measurement is preferably performed, for example, by using SmartLab manufactured by RIGAKU CORPORATION under conditions of a Cu bulb, a voltage of 40 kV, a current of 30 mA, a measurement angle (20) of 5 to 90°, a step of 0.02°, a scan speed of 1°/min., an incident slit of ½ deg., and a light receiving slit of 20 mm.

### <Water Content>

The water content of the insulating coating included in the grain-oriented electrical steel sheet according to the present embodiment is 0 to 0.04 mass %.

By lowering the water content of the insulating coating, dissolution of phosphoric acid can be curbed. By setting the water content to 0.04 mass % or less, a remarkable effect can be obtained.

In a normal insulating coating, the water content is about 0.05 to 0.15 mass %, but the water content can be made 0.04 mass % or less by setting the content of the alkaline earth metal element and the baking condition to predetermined ranges according to the content of the alkaline earth metal.

The water content can be determined by using the Karl Fischer method.

Specifically, about 3 g of a sample collected from a grain-oriented electrical steel sheet having an insulating coating is placed in a closed heating furnace and heated to 105 °C in a nitrogen gas stream to vaporize moisture. The vaporized moisture passes through 150 ml of an indicator solution in which a Karl Fischer reagent is dissolved, and the moisture is dissolved in the reagent solution for 30 minutes. Thereafter, quantitative analysis is performed by using a Karl Fischer titration method described in JIS K0113 (2005).

### <Adhesion Amount of Insulating Coating>

In the grain-oriented electrical steel sheet according to the present embodiment, the adhesion amount of the insulating coating is not particularly limited. For example, the coating amount of the insulating coating may be 1 to 10 g/m².

### [Manufacturing Method]

The grain-oriented electrical steel sheet according to the present embodiment can have the effect as long as it has the above composition regardless of a manufacturing method, but can be preferably manufactured by, for example, a manufacturing method including the following steps.
(i) a hot rolling step of heating a steel piece to form a hot rolled sheet through hot rolling,
(ii) a hot-rolled sheet annealing step of performing hot-rolled sheet annealing on the hot rolled sheet,
(iii) a pickling step of pickling the hot rolled sheet after the hot-rolled sheet annealing step;
(iv) a cold rolling step of subjecting the hot rolled sheet after the pickling step to cold rolling once or two or more times with annealing therebetween to form a cold rolled sheet,
(v) a decarburization annealing step of subjecting the cold rolled sheet to decarburization annealing,
(vi) a finishing annealing step of applying an annealing separator to front and back surfaces of the cold rolled sheet that is a base steel sheet after the decarburization annealing step and then performing finishing annealing,
(vii) a solution preparation step of preparing an insulating coating solution,
(viii) a coating and drying step of applying the insulating coating solution to the steel sheet after the finishing annealing step and heating the steel sheet to form an insulating coating, and
(ix) a magnetic domain refinement step of irradiating a surface of the insulating coating with an energy ray.

However, conditions for the steps other than the (vii) solution preparation step and the (viii) coating and drying step (collectively referred to as an insulating coating forming step) related to the formation of the insulating coating are not limited, and the steps can be performed under the known manufacturing conditions of the grain-oriented electrical steel sheet.

### [Hot Rolling Step]

In the hot rolling step, a steel piece such as a slab having a predetermined chemical composition (a chemical composition corresponding to the chemical composition of the base steel sheet of the grain-oriented electrical steel sheet according to the present embodiment) is heated and hot-rolled to form a hot rolled sheet.

The heating temperature of the steel piece is, for example, 1000 to 1400 °C.

The chemical composition of the steel piece to be subjected to the hot rolling may be determined in consideration of a change in the chemical composition in each step in accordance with the chemical composition desired to be obtained as the grain-oriented electrical steel sheet.

A method for obtaining a steel piece is not limited. For example, molten steel having a predetermined chemical composition may be melted and the steel piece may be manufactured by using the molten steel. The slab may be manufactured by using a continuous casting method, or an ingot may be manufactured by using the molten steel, and the slab may be manufactured by blooming-rolling the ingot. In addition, the slab may be manufactured by other methods.

The thickness of the steel piece is not particularly limited, and is, for example, 150 to 350 mm. The thickness of the steel piece is preferably 220 to 280 mm. As the steel piece, a so-called thin slab having a thickness of 10 to 70 mm may be used.

A so-called hot rolled sheet (hot-rolled steel sheet) is obtained through hot rolling. The sheet thickness of the hot rolled sheet (final sheet thickness) is not particularly limited. However, the hot rolled sheet is subjected to hot rolled sheet annealing, and is subjected to cold rolling after pickling, and it is known that the so-called cold rolling ratio affects the magnetic characteristics of the grain-oriented electrical steel sheet, and the sheet thickness of the hot rolled sheet is selected in consideration of the necessary cold rolling ratio with respect to the final sheet thickness. For example, the final sheet thickness of the hot rolled sheet is 2.0 to 4.0 mm.

### [Hot-Rolled Sheet Annealing Step]

In the hot-rolled sheet annealing step, the steel sheet (hot rolled sheet) after the hot rolling step is annealed. By performing such an annealing treatment, recrystallization occurs in the metallographic structure, and favorable magnetic characteristics can be realized.

In the hot-rolled sheet annealing step of the present embodiment, the hot rolled sheet manufactured through the hot rolling step may be annealed according to a known method. The means for heating the hot rolled sheet at the time of annealing is not particularly limited, and a known heating method can be adopted. For example, so-called continuous annealing may be used, and batch annealing may be used by using a hot rolled sheet having a coil shape. In addition, annealing conditions are also not particularly limited, but for example, the hot rolled sheet can be annealed in a temperature range of 900 to 1200 °C for 10 seconds to 5 minutes. The atmosphere is not particularly limited, but it is preferable to curb oxidation of the steel sheet, and it is preferable to perform annealing in a non-oxidizing atmosphere such as nitrogen, argon, or hydrogen.

### [Pickling Step]

In the pickling step, the scale (oxide) generated on the sheet surface through the hot rolling and hot-rolled sheet annealing is removed. In the pickling step of the present embodiment, a known method is used. As the pickling liquid, a known acid such as hydrochloric acid, sulfuric acid, or nitric acid is used. In addition, a known pickling inhibitor, a pickling accelerator, or the like may be added to the pickling liquid as necessary. Further, before the steel sheet is brought into contact with the pickling liquid, it is also possible to perform a physical treatment such as shot blasting on the steel sheet before pickling for the purpose of infiltrating the pickling liquid into the interface between the scale and the steel sheet to improve pickling efficiency.

### [Cold Rolling Step]

In the cold rolling step, the steel sheet after the pickling step is cold-rolled to form a cold rolled sheet. The cold rolling may be one time of cold rolling (a series of cold rolling without intermediate annealing). Before a final pass of the cold rolling step, cold rolling may be interrupted, at least one or more times of intermediate annealing may be performed, and a plurality of times of cold rolling may be performed with intermediate annealing interposed therebetween.

Conditions for the cold rolling may be in accordance with a known method. The cold rolling ratio in the grain-oriented electrical steel sheet greatly affects the magnetic characteristics thereof. In particular, the influence of the final rolling reduction ratio is large, and the final rolling reduction ratio can be set to 80 to 95%. The final rolling reduction is a cumulative rolling reduction of cold rolling, and when intermediate annealing is performed, the final rolling reduction is a cumulative rolling reduction of cold rolling after the final intermediate annealing.

In a case where the intermediate annealing is performed, it is preferable to hold the intermediate annealing at a temperature of 800 to 1200 °C for 5 to 180 seconds. The annealing atmosphere is not particularly limited, but in order to prevent oxidation of the steel sheet, the annealing is preferably performed in a non-oxidizing atmosphere such as nitrogen, argon, or hydrogen. In addition, as an annealing method, either so-called continuous annealing or batch annealing in a coil shape may be used, and other methods may be used. The number of times of intermediate annealing is preferably 3 or less in consideration of manufacturing cost.

### [Decarburization Annealing Step]

In the decarburization annealing step, the cold rolled sheet after the grinding step is subjected to decarburization annealing. In this decarburization annealing, C that adversely affects magnetic characteristics is removed (decarburized) from the steel sheet, and the cold rolled sheet is primarily recrystallized.

Although the decarburization annealing conditions are not limited, annealing is performed in an atmosphere in which oxygen potential is increased by humidification in a nitrogen-hydrogen mixed atmosphere for decarburization. In addition, since it is necessary to form a primary recrystallization texture together, the humidification temperature (dew point) is determined from the viewpoint of the annealing temperature necessary for recrystallization and the oxygen potential that can provide decarburization at the annealing temperature.

The annealing temperature is, for example, about 700 to 900 °C, and since annealing is generally performed in a continuous annealing step, heat is equalized for about 60 seconds.

### [Finishing Annealing Step]

In the finishing annealing step, an annealing separator is applied to the cold rolled sheet after the decarburization annealing step, and the finishing annealing is performed.

Since the annealing time is long, the finishing annealing is usually performed by coiling a steel sheet into a coil shape and performing batch annealing. Since the steel sheet temperature is increased to about 1200 °C, an annealing separator is applied so that the coiled steel sheet is not burn into each other. As the annealing separator, generally, MgO is mainly used. By using an annealing separator containing MgO as a main component as the annealing separator, a glass coating is formed on the surface of the steel sheet after the finishing annealing.

In the finishing annealing step, the primary recrystallized grains obtained in the decarburization annealing step are secondarily recrystallized by heating the steel sheet to obtain crystal grains having the Goss orientation, and in-steel precipitates such as nitrides (for example, AlN) and sulfides (for example, MnS) that have finished their roles as inhibitors are removed (purified) by holding the crystal grains at an annealing temperature close to 1200 °C for a predetermined time so as not to adversely affect magnetic characteristics.

Although the conditions for the finishing annealing are not limited, the temperature is raised in a range of 10 to 100 °C/h from room temperature, and raised by 5 to 20 °C/h in a temperature range of 900 to 1000 °C at which secondary recrystallization is generally caused in the Goss orientation, so that preferential growth (secondary recrystallization) is promoted in the Goss orientation, and then the inhibitor that has finished its role in the vicinity of 1200 °C (for example, 1150 to 1250 °C) as described above is purified. Thereafter, the coil is slowly cooled in a non-oxidizing atmosphere such as hydrogen or nitrogen and taken out from the furnace.

### <Solution Preparation Step>

In the solution preparation step, an insulating coating solution which contains 50 to 150 parts by mass of colloidal silica in terms of silica content and 1.25 to 83.3 parts by mass in total of a hydroxide or a hydrogen carbonate of an alkaline earth metal element other than magnesium with respect to 100 parts by mass of the metal phosphate and has a solid content concentration of 8 to 50 mass %, is prepared.

The blending ratio of the metal phosphate, the colloidal silica, or hydroxide or the hydrogen carbonate of the alkaline earth metal is a ratio for obtaining an insulating coating containing the metal phosphate, the amorphous silica, and the oxoacid compound at the above-described proportions in the insulating coating. In particular, the proportion of the hydroxide or hydrogen carbonate of alkaline earth metal is set in consideration of the proportion of the alkaline earth metal contained in the hydroxide or hydrogen carbonate such that the proportion of the alkaline earth metal in the insulating coating is 1.0 to 20 parts by mass with respect to 100 parts by mass of the metal phosphate. In other words, the insulating coating solution may contain 50 to 150 parts by mass of colloidal silica in terms of silica content and 1.0 to 20 parts by mass of the alkaline earth metal serving as a hydroxide or a hydrogen carbonate of an alkaline earth metal element other than magnesium with respect to 100 parts by mass of a metal phosphate, and may have a solid content concentration of 8 to 50 mass %.

When the solid content concentration is less than 8 mass %, the aqueous solution applied onto the steel sheet becomes unstable, which causes coating defects such as pattern and application unevenness. On the other hand, when the solid content concentration is more than 50 mass %, the pot life of the aqueous solution is shortened. In addition, since the solid content concentration also affects the amount of the oxoacid compound remaining in the insulating coating, the solid content concentration is set in consideration of this point.

In addition, the alkaline earth metal needs to be contained as a hydroxide or a hydrogen carbonate. This is because the effect of curbing the formation of magnesium phosphate cannot be obtained unless an alkaline earth metal is a hydroxide or a hydrogen carbonate because the alkaline earth metal is not sufficiently dissolved in an aqueous solution. In particular, since corrosion resistance is reduced in permanganate, it is not preferable to contain permanganate, and the amount of Mn in the solution is preferably 0.01 mol or less. In addition, since the alkaline earth metal is an inorganic compound in the insulating coating to be formed, the alkaline earth metal is contained in the solution to be a true solution instead of being dispersed or suspended.

To the insulating coating solution, it is preferable to add 1 to 5 parts by mass of phosphonic acid with respect to 100 parts by mass of the metal phosphate. In this case, the effect of improving the coatability is obtained.

### <Coating and Drying Step>

In the coating and drying step, an insulating coating solution is applied to a steel sheet (a steel sheet having a glass coating formed on a surface of the base steel sheet after finishing annealing), the steel sheet is heated to a temperature range of 800 to 900 °C so that a heating rate between 100 and 600 °C is 40 to 200 °C/sec, and held in this temperature range for 5 to 90 seconds to form an insulating coating (drying/baking).

When the heating rate at 100 to 600 °C is less than 40 °C/sec, moisture is less likely to evaporate from the surface layer of the coating, the dissolution property increases, and the water content also increases. On the other hand, when the heating rate exceeds 200 °C/sec, bumping or the like is likely to occur, and the water content also increases, which causes a decrease in corrosion resistance.

When the heating temperature is lower than 800 °C, a difference in thermal expansion between the steel sheet and the insulating coating is small, which causes a decrease in coating tension. When the temperature exceeds 900 °C, thermal strain is generated in the steel sheet, which causes occurrence of magnetostrain.

When the holding time is less than 5 seconds, the reaction between the phosphate and the alkaline earth metal hardly proceeds, which causes a decrease in coating tension. When the holding time exceeds 90 seconds, a coating crack is likely to occur, which causes a decrease in corrosion resistance.

### <Magnetic Domain Refinement Step>

In the magnetic domain refinement step, the surface (a surface of the insulating coating of the grain-oriented electrical steel sheet including the base steel sheet, the glass coating, and the insulating coating) of the insulating coating is irradiated with an energy ray to refine the 180° magnetic domain.

By refining the magnetic domain, the iron loss of the grain-oriented electrical steel sheet can be further reduced.

A known method may be used as the method of the magnetic domain refinement treatment. For example, there are a method of reducing the width of the 180° magnetic domain (refining the 180° magnetic domain) by forming linear or dotted groove parts extending in a direction intersecting the rolling direction at predetermined intervals in the rolling direction, and a method of reducing the width of the 180° magnetic domain (refining the 180° magnetic domain) by forming linear or dotted stress strain parts or groove parts extending in a direction intersecting the rolling direction at predetermined intervals in the rolling direction.

In a case where a stress-strain part is formed, laser beam irradiation, electron beam irradiation, and the like can be applied. In a case where a groove part is formed, a mechanical groove forming method using a gear or the like, a chemical groove forming method by electrolytic etching, a thermal groove forming method by laser irradiation, and the like can be applied.

In a case where the insulating coating is damaged due to formation of a stress-strain part or a groove part and characteristics such as insulation properties are deteriorated, the insulating coating may be formed again to repair the damage.

### EXAMPLES

A molten steel containing 3.2 mass % of Si, 0.027 mass % of sol. Al, 0.08 mass % of Mn, 0.008 mass % of N, and 0.08 mass % of C with the remainder of Fe and impurities was cast to obtain a slab.

After the slab was heated, hot rolling was performed to obtain a steel sheet (hot rolled sheet) having a thickness of 2.0 mm.

This steel sheet was annealed at 1100 °C for 5 minutes (hot-rolled sheet annealing), and then cooled.

The steel sheet after hot-rolled sheet annealing was subjected to pickling treatment and then cold rolling to obtain a steel sheet (cold rolled sheet) having a thickness of 0.23 mm.

The steel sheet was subjected to decarburization annealing in which the steel sheet was held at 850 °C for 3 minutes.

After the decarburization annealing, an annealing separator containing MgO as a main component (containing 90 mass % or more) was applied, and then finishing annealing was performed in which the annealing separator was heated to 1200 °C and held in a hydrogen stream at that temperature for 20 hours.

A sample of 7 cm in the width direction×30 cm in the rolling direction was cut out from the steel sheet after the finishing annealing, and the annealing separator remaining on the surface was removed through water washing and light pickling. However, the glass coating formed through the finishing annealing was left.

Thereafter, annealing (stress relief annealing) of holding the sample at 850 °C for 2 hours in a nitrogen stream was performed to obtain a sample material.

Next, a carbonate and a hydroxide containing an alkaline earth metal shown in Table 1 were added to an insulating coating treatment liquid containing a metal phosphate and colloidal silica as main components at a ratio shown in Table 2, and then the insulating coating treatment liquid was applied to a sample material after stress relief annealing and dried to form an insulating coating on the surface (in Table 2, the type of metal phosphate: proportion indicates that when Al: 100%, Al phosphate was 100% among the metal phosphate). The adhesion amount of the insulating coating was 5 g/m². As a result, the grain-oriented electrical steel sheet including the steel sheet (so-called a base steel sheet), the glass coating, and the insulating coating was obtained.

The grain-oriented electrical steel sheet thus obtained was irradiated with a laser beam to perform a magnetic domain refinement treatment. Laser irradiation was performed by using a continuous laser in a direction orthogonal to the rolling direction under the conditions of an irradiation pitch of 6 mm and an energy density of 2.0 mJ/mm².

TABLE 1

| Symbol | Name | Chemical Formula |
|---|---|---|
| A | Calcium Hydrogen Carbonate | Ca (HCO₃)₂ |
| B | Strontium Hydroxide | Sr (OH)₂ |
| C | Barium Hydroxide | Ba (OH)₂ |
| D | Zinc Hydroxide | Zn (OH)₂ |
| E | Zinc Carbonate | Zn (HCO₃)₂ |
| F | Manganese Hydroxide | Mn (OH)₂ |
| G | Calcium Permanganate | Ca (MnO₄)₂ |

TABLE 2

| | Solution Preparation | | | | | | | | | |
|---|---|---|---|---|---|---|---|---|---|---|
| | Insulating Coating Solution | | | | | | | | | |
| | Metal Phosphate | | | | | | | Coating and Drying | | |
| | 100 parts | Silica Content | | | | | | Coating and Drying Conditions | | |
| | by mass | of Colloidal | Alkaline Earth Metal | | | | | Heating Rate | | |
| | Type: | Silica | Hydroxide/Carbonate | | Solid Content | Additive | | at 100 to | | |
| | Proportion | parts by | | parts by | Concentration | | parts by | 600 °C | Temperature | Time |
| | (mass %) | mass | Type | mass | mass % | Type | mass | (°C/sec) | (°C) | (sec) |
| Invention | Al: 100 | 70 | A | 70.0 | 40 | | | 70 | 850 | 45 |
| Example 1 | | | | | | | | | | |
| Invention | Al: 100 | 75 | B | 20.0 | 30 | | | 60 | 850 | 60 |
| Example 2 | | | | | | | | | | |
| Invention | Al: 100 | 75 | B | 16.0 | 30 | | | 55 | 870 | 45 |
| Example 3 | | | | | | | | | | |
| Invention | Al: 100 | 100 | C | 20.0 | 15 | | | 80 | 820 | 50 |
| Example 4 | | | A | 30.0 | | | | | | |
| Invention | Al: 100 | 80 | B | 26.0 | 20 | Phosphonic | 2 | 95 | 850 | 80 |
| Example 5 | | | | | | Acid | | | | |
| Invention | Al: 100 | 140 | A | 25.0 | 40 | | | 53 | 850 | 10 |
| Example 6 | | | | | | | | | | |
| Comparative | Al: 100 | 70 | B | 0.50 | 30 | | | 30 | 850 | 45 |
| Example 1 | | | | | | | | | | |
| Comparative | Al: 100 | 75 | B | 85.0 | 20 | | | 50 | 880 | 45 |
| Example 2 | | | | | | | | | | |
| Comparative | Al: 100 | 70 | C | 0.20 | 30 | | | 70 | 850 | 45 |
| Example 3 | | | | | | | | | | |
| Comparative | Al: 100 | 75 | C | 90.0 | 12 | | | 70 | 870 | 45 |
| Example 4 | | | | | | | | | | |
| Comparative | Al: 100 | 170 | A | 8.00 | 7 | | | 70 | 850 | 45 |
| Example 5 | | | | | | | | | | |
| Comparative | Al: 100 | 40 | A | 8.00 | 30 | | | 70 | 820 | 10 |
| Example 6 | | | | | | | | | | |
| Comparative | Al: 100 | 55 | E | 6.00 | 55 | | | 70 | 820 | 80 |
| Example 7 | | | | | | | | | | |
| Comparative | Al: 100 | 55 | D | 7.00 | 40 | | | 70 | 820 | 60 |
| Example 8 | | | | | | | | | | |
| Comparative | Al: 100 | 55 | F | 8.00 | 30 | | | 70 | 850 | 45 |
| Example 9 | | | | | | | | | | |
| Comparative | Al: 100 | 55 | — | 0.00 | 30 | | | 220 | 850 | 45 |
| Example 10 | | | | | | | | | | |
| Comparative | Al: 100 | 55 | G | 8.00 | 30 | | | 70 | 850 | 30 |
| Example 11 | | | | | | | | | | |
| Comparative | Al: 100 | 75 | A | 50.0 | 30 | | | 20 | 850 | 40 |
| Example 12 | | | | | | | | | | |
| Comparative | Al: 100 | 75 | B | 16.0 | 30 | | | 220 | 870 | 40 |
| Example 13 | | | | | | | | | | |

The chemical composition of the base steel sheet of the obtained grain-oriented electrical steel sheet contained Si: 3.2 mass %, sol. Al: 0.01 mass %, Mn: 0.07 mass %, N: less than 0.001 mass %, and C: 0.001 mass %, with the remainder of Fe and impurities.

In addition, the content (parts by mass) of the amorphous silica and the alkaline earth metal element other than magnesium when the amount of the metal phosphate in the insulating coating was 100 parts by mass was measured in the same manner as described above by using an energy dispersive X-ray analyzer. Table 3 shows the results. Although not shown in the table, it was inferred from the presence position that the alkaline earth metal was contained in the insulating coating as a metal phosphate.

After the formation of the insulating coating, the water content of the insulating coating of the grain-oriented electrical steel sheet was measured by using the Karl Fischer method (current titration method) after 24 hours of holding at room temperature.

Specifically, about 3 g of a sample is placed in a closed heating furnace and heated to 105 °C in a nitrogen gas stream to vaporize moisture. The vaporized moisture passes through 150 ml of the indicator solution in which the Karl Fischer reagent was dissolved, and the moisture was dissolved in the reagent solution for 30 minutes, and then quantitatively analyzed by using the Karl Fischer titration method described in JIS K0113 (2005). Table 3 shows the results.

TABLE 3

| | Insulating Coating | | | |
|---|---|---|---|---|
| | Content at 100 parts by mass of Metal Phosphate | | | |
| | | Alkaline Earth Metal | | |
| | Amorphous Silica | | parts by | Water Content |
| | (parts by mass) | Type | mass | (mass %) |
| Invention Example 1 | 70 | A | 17 | 0.01 |
| Invention Example 2 | 75 | B | 14 | 0.01 |
| Invention Example 3 | 75 | B | 12 | 0.01 |
| Invention Example 4 | 100 | C | 16 | 0.03 |
| | | A | 7 | |
| Invention Example 5 | 80 | B | 19 | 0.01 |
| Invention Example 6 | 140 | A | 6 | 0.03 |
| Comparative Example 1 | 70 | B | 0.4 | 0.07 |
| Comparative Example 2 | 75 | B | 61 | 0.04 |
| Comparative Example 3 | 70 | C | 0.2 | 0.06 |
| Comparative Example 4 | 75 | C | 72 | 0.05 |
| Comparative Example 5 | 170 | A | 2 | 0.06 |
| Comparative Example 6 | 40 | A | 2 | 0.08 |
| Comparative Example 7 | 55 | E | 2 | 0.07 |
| Comparative Example 8 | 55 | D | 5 | 0.06 |
| Comparative Example 9 | 55 | F | 5 | 0.05 |
| Comparative Example 10 | 55 | — | 0.0 | 0.08 |
| Comparative Example 11 | 55 | G | 1.2 | 0.05 |
| Comparative Example 12 | 75 | A | 12 | 0.05 |
| Comparative Example 13 | 75 | B | 12 | 0.05 |

In addition, the obtained grain-oriented electrical steel sheet was evaluated for coating tension, coating adhesion, peelability, magnetic characteristics, corrosion resistance, and dissolution resistance in the following manner.

In the measurement, corrosion resistance was measured after 24 hours of holding at room temperature after formation of the insulating coating, and coating tension, coating adhesion, peelability, magnetic characteristics, and dissolution resistance were measured after 168 hours of aging at a constant temperature and humidity of 50 °C×80% in order to measure characteristics after moisture absorption.

### <Coating Tension>

The coating tension was calculated by back calculation from the curved state when one surface of the insulating coating was peeled off.

When the obtained coating tension was 4.0 MPa or more, it was determined that the coating had a sufficient coating tension.

### <Coating Adhesion>

Adhesion was evaluated through a bending adhesion test by using a 10 mmφ cylinder after stress relief annealing of a sample having a width of 30 mm and a length of 300 mm at 800 °C for 2 hours in a nitrogen stream. The evaluation criteria were as follows according to the peeling width, and when the peeling width was 3 or more (3 to 5), it was determined that the coating adhesion was sufficient.
5: No peeling
4: Almost no peeling (peeling portion is 1 mm or less)
3: Peeling with a width of more than 1 mm to less than ⅓ was observed
2: Peeling with a width of ⅓ to ½ was observed
1: Peeling width of more than ½ or over the entire

### <Peelability>

A felt was bonded in a disk shape having a diameter of 100 mm, and the surface of the sample was rubbed with the disk under pressure at 100 MPa at 300 rpm for 5 minutes. Thereafter, a trace of the insulating coating attached to the felt was visually evaluated, and when the value was 3 or more (3 to 5), it was determined that the felt had sufficient peelability.
5: Almost no peeling
4: Extremely slightly peeled off
3: Traces of peeling of insulating coating were observed in some places
2: There was a trace of thin peeling of the insulating coating on the entire surface of the felt
1: Powder of the peeled insulating coating was attached to the felt surface

### <Magnetic Characteristics>

B8 (magnetic flux density at a magnetizing force of 800 A/m) and W17/50 (iron loss per mass at amplitude of magnetic flux density of 1.7 T and 50 Hz) were measured. These characteristic values were measured by using a single sheet tester (SST) in accordance with JIS C2556 (2015).

### <Corrosion Resistance>

After the formation of the insulating coating, a 5% NaCl aqueous solution was naturally dropped to the sample for 7 hours in an atmosphere at 35 °C in accordance with the salt spray test method described in JIS Z2371 (2015) with respect to the grain-oriented electrical steel sheet held at room temperature after a lapse of 24 hours.

The rusting area was evaluated by 10 points. The evaluation criteria were as follows. If a score was 5 or more (5 to 10), it was determined that the steel sheet had sufficient corrosion resistance.
10: No rust was generated
9: Rust was generated in an extremely small amount (area ratio of 0.10% or less)
8: Rust was generated in an area ratio of more than 0.10% and 0.25% or less
7: Rust was generated in an area ratio of more than 0.25% and 0.50% or less
6: Rust was generated in an area ratio of more than 0.50% and 1.0% or less
5: Rust was generated in an area ratio of more than 1.0% and 2.5% or less
4: Rust was generated in an area ratio of more than 2.5% and 5% or less
3: Rust was generated in an area ratio of more than 5% and 10% or less
2: Rust was generated in an area ratio of more than 10% and 25% or less
1: Rust was generated in an area ratio of more than 25%

### <Dissolution Resistance>

The amount of phosphoric acid eluted from the sample was measured.

The sample was boiled in boiled pure water for 10 minutes, the amount of phosphoric acid eluted in the pure water was measured, and the amount of phosphoric acid was divided by the area of the insulating coating of the boiled grain-oriented electrical steel sheet to obtain the dissolution amount. The amount of phosphoric acid eluted in the pure water was calculated by cooling the pure water (solution) in which phosphoric acid was eluted, diluting the cooled solution with pure water, and measuring the phosphoric acid concentration of the sample by using ICP-AES.

When the dissolution amount was less than 40 mg/m², it was determined that the dissolution resistance was exceptional.

TABLE 4

| | Insulating Coating Characteristics | | | | | Magnetic | | Remarks |
|---|---|---|---|---|---|---|---|---|
| | | | Coating | | | Characteristics | | Treatment Liquid |
| | | Corrosion | Tension | | Dissolution | B8 | W17/50 | Stability/Surface |
| | Adhesion | Resistance | (MPa) | Peelability | Resistance | (T) | (W/kg) | Appearance/etc. |
| Invention | 4 | 9 | 9.1 | 4 | 18 | 1.92 | 0.69 | Uniform Color Tone |
| Example 1 | | | | | | | | |
| Invention | 5 | 9 | 10.0 | 5 | 10 | 1.93 | 0.68 | Glossy/Uniform |
| Example 2 | | | | | | | | |
| Invention | 4 | 9 | 9.5 | 4 | 14 | 1.94 | 0.67 | Uniform Color Tone |
| Example 3 | | | | | | | | |
| Invention | 5 | 9 | 8.9 | 4 | 29 | 1.93 | 0.65 | Uniform Color Tone |
| Example 4 | | | | | | | | |
| Invention | 4 | 8 | 8.4 | 4 | 19 | 1.92 | 0.67 | Uniform Color Tone |
| Example 5 | | | | | | | | |
| Invention | 4 | 8 | 8.6 | 3 | 33 | 1.92 | 0.69 | Uniform Color Tone |
| Example 6 | | | | | | | | |
| Comparative | 2 | 8 | 6.5 | 4 | 48 | 1.93 | 0.71 | No Gloss but Uniform |
| Example 1 | | | | | | | | |
| Comparative | 4 | 4 | 7.0 | 2 | 39 | 1.92 | 0.73 | Grayish White/Nonuniform |
| Example 2 | | | | | | | | |
| Comparative | 4 | 6 | 3.9 | 4 | 49 | 1.93 | 0.71 | Glossy/Uniform |
| Example 3 | | | | | | | | |
| Comparative | 3 | 4 | 5.9 | 2 | 38 | 1.93 | 0.74 | Grayish White/Nonuniform |
| Example 4 | | | | | | | | |
| Comparative | 2 | 3 | 5.4 | 2 | 46 | 1.93 | 0.77 | White/Nonuniform |
| Example 5 | | | | | | | | |
| Comparative | 4 | 9 | 3.1 | 2 | 54 | 1.92 | 0.82 | Glossy/Uniform |
| Example 6 | | | | | | | | |
| Comparative | 3 | 7 | 4.5 | 2 | 51 | 1.92 | 0.79 | No Gloss but Uniform |
| Example 7 | | | | | | | | |
| Comparative | 4 | 8 | 5.1 | 3 | 42 | 1.92 | 0.8 | No Gloss but Uniform |
| Example 8 | | | | | | | | |
| Comparative | 3 | 7 | 4.6 | 2 | 46 | 1.92 | 0.82 | No Gloss but Uniform |
| Example 9 | | | | | | | | |
| Comparative | 4 | 8 | 6.7 | 3 | 49 | 1.94 | 0.73 | Uniform Color Tone |
| Example 10 | | | | | | | | |
| Comparative | 6 | 4 | 4.5 | 2 | 60 | 1.92 | 0.76 | Grayish White/Nonuniform |
| Example 11 | | | | | | | | |
| Comparative | 5 | 7 | 5.5 | 2 | 60 | 1.93 | 0.78 | Uniform Color Tone |
| Example 12 | | | | | | | | |
| Comparative | 2 | 4 | 7.5 | 3 | 35 | 1.92 | 0.77 | No Gloss but Uniform |
| Example 13 | | | | | | | | |

As can be seen from the results in Tables 1 to 4, in Invention Examples 1 to 6, the insulating coating contained a metal phosphate, amorphous silica, and an alkaline earth metal element other than magnesium, the amorphous silica was 50 to 150 parts by mass, the alkaline earth metal element was 1.0 to 20 parts by mass in total, with respect to 100 parts by mass of the metal phosphate, and the water content of the insulating coating was 0 to 0.04 mass %. As a result, it was exceptional in all of adhesion, corrosion resistance, coating tension, peelability, and dissolution resistance.

On the other hand, in Comparative Example 1, the proportion of the alkaline earth metal was small, and the water content was high. Therefore, dissolution resistance was low. In addition, since the heating rate was low, coating defects occurred, and the adhesion was reduced.

In Comparative Example 3, the amount of the alkaline earth metal was small, and the water content was high. Therefore, dissolution resistance was low. The coating tension was also low.

In Comparative Examples 2 and 4, the proportion of alkaline earth metal in the insulating coating was excessively large, and corrosion resistance and peelability deteriorated.

In Comparative Example 5, the proportion of the amorphous silica in the insulating coating was excessively large, the water content of the insulating coating was increased, and the adhesion, the peelability, the corrosion resistance, and the dissolution resistance were low.

In Comparative Example 6, the proportion of amorphous silica in the insulating coating was excessively low, the water content of the insulating coating was high, and the coating tension, peelability, and dissolution resistance were low.

In Comparative Examples 7 to 11, the insulating coating did not contain a predetermined alkaline earth metal element, and the water content of the insulating coating was high. As a result, the dissolution resistance was low. In addition, the peelability and corrosion resistance were also low for some of the samples.

In Comparative Example 12, since the heating rate during coating and drying was low, the water content of the insulating coating was high. As a result, dissolution resistance and peelability were low.

In Comparative Example 13, bumping occurred due to a high heating rate during coating and drying, and the water content of the insulating coating was high. As a result, adhesion and corrosion resistance were low.

### INDUSTRIAL APPLICABILITY

According to the present invention, it is possible to provide a grain-oriented electrical steel sheet in which the amount of phosphoric acid eluted from an insulating coating is small, and a method for forming the insulating coating. Therefore, industrial applicability is high.

1. A grain-oriented electrical steel sheet comprising:
a base steel sheet;
a glass coating on a surface of the base steel sheet; and
an insulating coating on a surface of the glass coating, wherein
the base steel sheet has a sheet thickness of 0.15 to 0.35 mm,
the insulating coating contains a metal phosphate, amorphous silica, and an alkaline earth metal element other than magnesium, the amorphous silica contained in an amount of 50 to 150 parts by mass, and the alkaline earth metal element contained in an amount of 1.0 to 20 parts by mass in total, with respect to 100 parts by mass of the metal phosphate, and
the insulating coating has a water content of 0 to 0.04 mass %.

2. The grain-oriented electrical steel sheet according to claim 1, wherein
the alkaline earth metal element is one or more of Ca, Sr, and Ba.

3. An insulating coating forming method comprising:
a solution preparation step of preparing an insulating coating solution containing 50 to 150 parts by mass of colloidal silica in terms of silica content and 1.25 to 83.3 parts by mass of a hydroxide or a hydrogen carbonate of an alkaline earth metal element other than magnesium with respect to 100 parts by mass of a metal phosphate, the insulating coating solution having a solid content concentration of 8 to 50 mass %; and
a coating and drying step of applying the insulating coating solution to a steel sheet, heating the steel sheet to a temperature range of 800 to 900 °C so that a heating rate between 100 and 600 °C is 40 to 200 °C/sec, and holding the insulating coating solution in the temperature range for 5 to 90 seconds.

4. The insulating coating forming method according to claim 3, wherein
in the solution preparation step, 1 to 5 parts by mass of phosphonic acid with respect to 100 parts by mass of the metal phosphate is added to the insulating coating solution.
